(19) United States
(12) Patent Application Publication
(10) Pub. No.: US 2026/0230955 A1
(43) Pub. Date: Aug. 6, 2026

(54) METHOD AND APPARATUS FIR TRANSMITTING INDICATION INFORMATION, AND READABLE STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 19/148,563

(22) PCT Filed: Jan. 18, 2023
(86) PCT No.: PCT/CN2023/072977

§ 371 Date: Jul. 16, 2025

(51) Int. Cl. H04W 36/00; H04B 7/06; H04W 72/21

(52) U.S. Cl. CPC H04W 36/0072; H04B 7/0626; H04W 72/21

(57) ABSTRACT

The present disclosure provides a method and apparatus for transmitting indication information, and a readable storage medium. The method includes: sending indication information to a network device, the indication information being used for indicating that a handover process of a user equipment from a serving cell to a first candidate cell has been completed, wherein the network device includes a first network device corresponding to the serving cell, or a second network device corresponding to the first candidate cell.

### CROSS REFERENCE

The present application is a U.S. National Stage of International Application No. PCT/CN2023/072977, filed on Jan. 18, 2023, the contents of which are incorporated herein by reference in its entirety for all purposes.

### TECHNICAL FIELD

The present disclosure relates to the field of wireless communication technologies, and in particular to a method and apparatus for transmitting indication information, and a readable storage medium.

### BACKGROUND

In 5G New Radio (NR) communication systems, signal qualities of a current serving cell and a candidate cell is determined based on a layer 3 (L3) measurement result.

### SUMMARY

The present disclosure provides a method and apparatus for transmitting indication information, and a readable storage medium.

In a first aspect, the present disclosure provides a method for sending indication information, which is performed by a user equipment, and the method includes:
sending indication information to a network device, wherein the indication information is configured to indicate that a handover process of handover of the user equipment from a serving cell to a first candidate cell is completed; and
wherein the network device includes a first network device corresponding to the serving cell, or a second network device corresponding to the first candidate cell.

In a second aspect, the present disclosure provides a method for transmitting indication information, which is performed by a first network device corresponding to a serving cell, and the method includes:
receiving indication information sent by a user equipment, wherein the indication information is configured to indicate that a handover process of handover of the user equipment from the serving cell to a first candidate cell is completed; and
sending the indication information to a second network device, wherein the second network device corresponds to the first candidate cell.

In a third aspect, the present disclosure provides a method for receiving indication information, which is performed by a second network device corresponding to a first candidate cell, and the method includes:
receiving indication information sent by a user equipment, or receiving the indication information sent by a first network device, wherein the indication information is configured to indicate that a handover process of handover of the user equipment from a serving cell to the first candidate cell is completed; and
wherein the first network device corresponds to the serving cell.

In a fourth aspect, the present disclosure provides a user equipment, including a processor and a memory; the memory is configured to store a computer program; and the processor is configured to perform the computer program to implement the first aspect or any possible design thereof.

In a fifth aspect, the present disclosure provides a network device, including a processor and a memory; the memory is configured to store a computer program; and the processor is configured to perform the computer program to implement the second aspect or any possible design thereof or the third aspect or any possible design thereof.

In a sixth aspect, the present disclosure provides a computer-readable storage medium having instructions (or called computer programs, programs) stored thereon, wherein the instructions, when invoked and executed on a computer, cause the computer to perform the first aspect or any possible design thereof.

It is to be understood that the foregoing general description and the following detailed description are exemplary and explanatory only and are not restrictive of the present disclosure.

### BRIEF DESCRIPTION OF THE DRAWINGS

The accompanying drawings described herein are used to provide a further understanding of embodiments of the present disclosure, and constitute a part of the present disclosure. The illustrative examples and descriptions of embodiments of the present disclosure are used to explain the embodiments of the present disclosure without constituting any improper limitations on the embodiments of the present disclosure.

The accompanying drawings, which are incorporated in and constitute a part of this specification, illustrate embodiments consistent with the present disclosure, and together with the description serve to explain the principles of the embodiments of the present disclosure.

FIG. 1 is a schematic diagram of a wireless communication system architecture provided by an embodiment of the present disclosure;

FIG. 2 is a flowchart showing a method for transmitting indication information according to an embodiment of the present disclosure;

FIG. 3 is a flowchart showing another method for transmitting indication information according to an embodiment of the present disclosure;

FIG. 4 is a flowchart showing a method for sending indication information according to an embodiment of the present disclosure;

FIG. 5 is a flowchart showing another method for sending indication information according to an embodiment of the present disclosure;

FIG. 6 is a flowchart showing a method for transmitting indication information according to an embodiment of the present disclosure;

FIG. 7 is a flowchart showing a method for transmitting indication information according to another embodiment of the present disclosure;

FIG. 8 is a flowchart showing a method for receiving indication information according to an embodiment of the present disclosure;

FIG. 9 is a block diagram showing an apparatus for sending indication information according to an embodiment of the present disclosure;

FIG. 10 is a block diagram showing a user equipment according to an embodiment of the present disclosure;

FIG. 11 is a block diagram showing an apparatus for transmitting indication information according to an embodiment of the present disclosure;

FIG. 12 is a block diagram showing a network device according to an embodiment of the present disclosure; and

FIG. 13 is a block diagram showing an apparatus for receiving indication information according to an embodiment of the present disclosure.

### DETAILED DESCRIPTION

Embodiments of the present disclosure will now be further described with reference to the accompanying drawings and specific implementations.

Embodiments will be described in detail herein, examples of which are illustrated in the accompanying drawings. Where the following description refers to the drawings, the same numerals in different drawings refer to the same or similar elements unless otherwise indicated. The implementations described in the following embodiments are not intended to represent all implementations consistent with the disclosed embodiments. Rather, they are merely examples of apparatus and methods consistent with some aspects of the present disclosure as defined in the appended claims.

The terms used in embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that although the terms first, second, third, etc. may be used in embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determination”.

Embodiments of the present disclosure are described in detail below, examples of which are shown in the accompanying drawings, where the same or similar reference numerals throughout represent the same or similar elements. The embodiments described below with reference to the accompanying drawings are illustrative and are intended to explain the present disclosure, and should not be construed as limiting the present disclosure.

As shown in FIG. 1, a method for transmitting indication information provided by embodiments of the present disclosure may be applied to a wireless communication system 100, which may include a user equipment 101, a first network device 102, and a second network device 103. The user equipment 101 is configured to support carrier aggregation, and may be connected to a plurality of carrier units of the first network device 102 or the second network device 103, including one primary carrier unit and one or more secondary carrier units.

The user equipment 101 may be configured with a plurality of cells as serving cells. The serving cell may include a serving cell (active serving cell) currently accessed by the user equipment 101, such as a primary serving cell (active PCell) or a primary secondary serving cell (active PSCell). The serving cell may also include a plurality of candidate serving cells (candidate serving cell(s)).

The first network device 102 is a network device corresponding to a serving cell (i.e., a source cell) currently accessed by the user equipment 101.

During a cell handover process, the user equipment 101 hands over from the currently connected serving cell to one of a plurality of candidate cells, and the selected candidate cell is a first candidate cell (i.e., a target cell) in embodiments of the present disclosure. The second network device 103 is a network device corresponding to the first candidate cell.

It should be understood that the above wireless communication system 100 is applicable to both low frequency scenarios and high frequency scenarios. Application scenarios of the wireless communication system 100 include, but are not limited to, long term evolution (LTE) system, LTE frequency division duplex (FDD) system, LTE time division duplex (TDD) system, worldwide interoperability for microwave access (WiMAX) communication system, cloud radio access network (CRAN) system, future 5th-Generation (5G) system, new radio (NR) communication system, future-evolved public land mobile network (PLMN) system, or the like.

The user equipment 101 described above may be a terminal, an access terminal, a terminal unit, a terminal station, a mobile station (MS), a remote station, a remote terminal, a mobile terminal, a wireless communication device, a terminal agent, a terminal device, or the like. The user equipment 101 may have a wireless transceiver function, which can perform communication (e.g., wireless communication) with one or more network devices of one or more communication systems, and accept network services provided by the network device, where the network device includes, but is not limited to, the network service 103 as illustrated.

The user equipment 101 may be a cellular phone, a cordless phone, a session initiation protocol (SIP) phone, a wireless local loop (WLL) station, a personal digital assistant (PDA) device, a handheld device with wireless communication functions, a computing device or another processing device connected to wireless modems, an in-vehicle device, a wearable device, a terminal device in future 5G networks, a terminal device in future-evolved PLMN networks, or the like.

The first network device 102 or the second network device 103 may be an access network device (or an access network station). The access network device refers to a device that provides a network access function, such as a radio access network (RAN) base station, and the like. The network device 102 may specifically include a base station (BS), or include a base station and a radio resource management device for controlling the base station, and the like. The network device 102 may also include a relay station (relay device), an access point, a base station in a future 5G network, a base station in a future-evolved PLMN network, an NR base station, or the like. The network device 102 may be a wearable device or a vehicle-mounted device. The network device 102 may also be a communication chip with a communication module.

For example, the first network device 102 or the second network device 103 includes, but is not limited to, a next-generation base station (gnodeB, gNB) in 5G, an evolved node B (eNB) in the LTE system, a radio network controller (RNC), a Node B (NB) in WCDMA system, a wireless controller in CRAN system, a base station controller (BSC), a base transceiver station (BTS) in GSM system or CDMA system, a home base station (e.g., home evolved nodeB; or home node B, HNB), a baseband unit (BBU), a transmitting and receiving point (TRP), a transmitting point (TP), mobile handover center, or the like.

A handover delay of cell handover based on the beam measurement of layer 1 (L1) or layer 2 (L2) is shorter than that of cell handover based on the L3 measurement. In the cell handover process of L1/L2 measurement, the user equipment 101 determines the signal qualities of the serving cell and the candidate cell through a layer 1 measurement result, the first network device 102 triggers the cell handover according to the layer 1 measurement result (such as L1-RSRP) reported by the user equipment 101, and the user equipment 101 performs the corresponding cell handover process. Regardless of the cell handover based on the L1/L2 measurement or the cell handover based on the L3 measurement, after the first network device 102 sends the handover instruction, the second network device 103 does not know when the user equipment 101 completes the handover.

As described above, in 5G New Radio (NR) communication systems, signal qualities of a current serving cell and a candidate cell is determined based on a layer 3 (L3) measurement result. A handover delay in the measurement process is long, in particular, in a FR2 scenario where the cell coverage is relatively small, the excessive handover delay not only affects the throughput and mobility performance of the serving cell, but also causes that the candidate cell selected for handover, i.e. a target cell, cannot learn in time whether the user equipment has completed the handover.

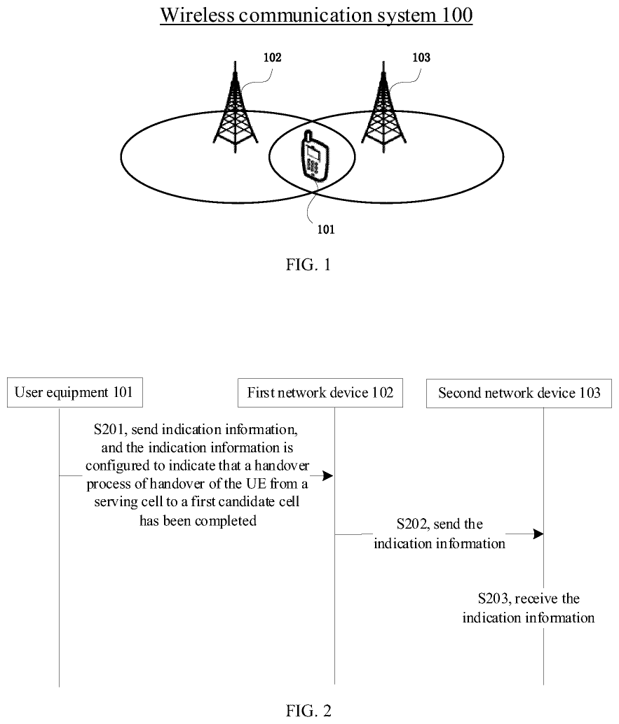

Embodiments of the present disclosure provide a method for transmitting indication information. Reference is made to FIG. 2, which shows a method for transmitting indication information according to an embodiment. As shown in FIG. 2, the method includes steps S201 to S203. Specifically:
in the step S201, the user equipment 101 sends indication information to first network device 102, and the indication information is configured to indicate that a handover process of handover of the user equipment 101 from a serving cell to a first candidate cell has been completed. The first network device 102 corresponds to the serving cell.

The first candidate cell is a target cell, that is, a candidate cell whose channel quality is determined, based on layer 1 measurement results of the user equipment 101 for a plurality of candidate cells, by the first network device 102, as meeting the requirement.

In some implementations, the user equipment 101 may perform cell handover based on a handover command from the first network device 102.

In some implementations, the user equipment 101 sends the indication information after completing the cell handover.

In some implementations, the user equipment 101 may send the indication information through a Media Access Control Control Element (MAC-CE) signaling or Uplink Control Information (UCI).

In the step S202, the first network device 102 receives the indication information, and sends the indication information to the second network device 103. The second network device 103 corresponds to the first candidate cell.

In some implementations, the first network device 102 may not process the indication information, and directly forward it to the second network device 103.

In some implementations, the signaling interaction or information interaction between the first network device 102 and the second network device 103 is performed based on the Xn interface.

For example, the first network device 102 sends the indication information to the second network device 103 through the Xn interface.

In the step S203, the second network device 103 receives the indication information sent by the first network device 102.

In some implementations, the second network device 103 receives, based on the Xn interface, the indication information sent by the first network device 102 to learn that the user equipment 101 completes the cell handover.

In some implementations, after receiving the indication information, the second network device 103 may schedule the user equipment 101 in a timely manner, such as scheduling a Physical Downlink Control Channel (PDCCH) or a Physical Downlink Shared Channel (PDSCH).

In embodiments of the present disclosure, the user equipment 101 may send the indication information to the first network device 102, so as to inform the second network device 103 through the first network device 102 that the cell handover is completed. Thus, the second network device 103 can timely learn that the user equipment 101 completes the cell handover, so as to perform reasonable operations at an appropriate time. This method is suitable for a scenario where the second network device 103 may not monitor the uplink information of the user equipment 101 in a timely manner. The user equipment 101 first sends the indication information to the first network device 102 of the serving cell, and the indication information is timely transmitted based on a communication mode between the network devices, so as to ensure that the second network device 103 can timely learn the handover status of the user equipment 101.

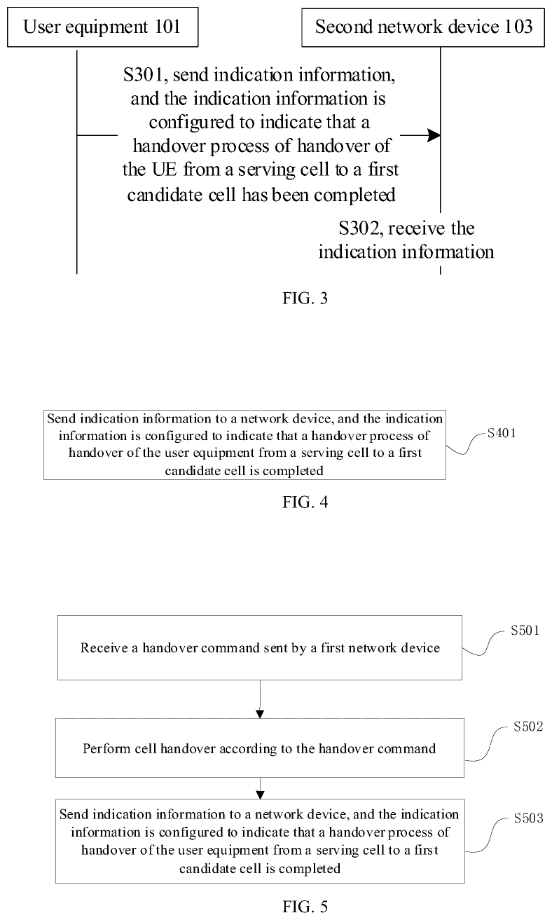

Embodiments of the present disclosure provide a method for transmitting indication information. Reference is made to FIG. 3, which shows a method for transmitting indication information according to an embodiment. As shown in FIG. 3, the method includes steps S301 to S302. Specifically:
in the step S301, the user equipment 101 sends indication information to second network device 103, and the indication information is configured to indicate that a handover process of handover of the user equipment 101 from a serving cell to a first candidate cell has been completed. The second network device 103 corresponds to the first candidate cell.

In some implementations, after receiving a handover command from the first network device 102, the user equipment 101 sends the indication information, such as after completing the cell handover.

In some implementations, before sending the indication information, the user equipment 101 has accessed the second network device 103 and completed uplink and downlink synchronization with the second network device 103.

In the step S302, the second network device 103 receives the indication information sent by the user equipment 101.

In some implementations, after receiving the indication information, the second network device 103 may schedule the user equipment 101 in a timely manner, such as scheduling the PDCCH or the PDSCH.

In embodiments of the present disclosure, the user equipment 101 can send the indication information to the second network device 103 to report the completion of the cell handover to the second network device 103 through the direct transmission. Thus, the second network device 103 can timely learn that the user equipment 101 completes the cell handover, so as to perform reasonable operations at an appropriate time. In this method, in combination with the change in channel quality of the cell before and after the handover in the handover scenario, in the case of a change in the serving cell, the communication quality between the user equipment 101 and the second network device 103 may be better, so the method in which the user equipment 101 directly reports the indication information to the second network device 103 can reduce an information delay, reduce a transmission delay, and further ensure that the second network device 103 learns in time that the user equipment 101 completes the cell handover and can quickly perform scheduling.

Embodiments of the present disclosure provide a method for sending indication information, which is performed by the user equipment 101. Reference is made to FIG. 4, which shows a method for sending indication information according to an embodiment. As shown in FIG. 4, the method includes a step S401. Specifically:

In the step S401, the user equipment 101 sends indication information to a network device, and the indication information is configured to indicate that a handover process of handover of the user equipment from a serving cell to a first candidate cell has been completed.

The network device includes the first network device 102 corresponding to the serving cell, or the second network device 103 corresponding to the first candidate cell.

In some implementations, the user equipment 101 sends the indication information after completing the cell handover.

In some implementations, when the network device is the first network device 102, that is, the user equipment 101 sends the indication information to the first network device 102. The first network device 102 sends the indication information to the second network device 103 based on the Xn interface. In the implementation, the user equipment 101 sends the indication information to the second network device 103 via the first network device 102 to inform the second network device 103 that the cell handover has been completed.

In some implementations, when the network device is the second network device 103, that is, the user equipment 101 directly sends the indication information to the second network device 103. Before sending the indication information, the user equipment 101 has accessed the second network device 103, and completed the uplink and downlink synchronization with the second network device 103. In the implementation, the user equipment 101 directly reports the indication information to the second network device 103 to inform the second network device 103 that the cell handover has been completed.

In embodiments of the present disclosure, the user equipment 101 may send the indication information to the first network device 102 or the second network device 103, so as to inform the second network device 103 through the first network device 102 that the cell handover is completed, or report the completion of the cell handover to the second network device 103 through the direct transmission. Thus, the second network device 103 can timely learn that the user equipment 101 completes the cell handover, so as to perform reasonable operations at an appropriate time.

Embodiments of the present disclosure provide a method for sending indication information, which is performed by the user equipment 101. Reference is made to FIG. 5, which shows a method for sending indication information according to an embodiment. As shown in FIG. 5, the method includes steps S501 to S503. Specifically:
in the step S501, the user equipment 101 receives a handover command sent by the first network device 102.

In some implementations, the user equipment 101 receives the handover command sent, through a MAC-CE signaling, by the first network device 102.

In some implementations, after receiving layer 1 measurement results of the user equipment 101 based on the plurality of candidate cells, the first network device 102 makes a decision to determine the first candidate cell (i.e., the target cell). After determining the first candidate cell, the first network device 102 may send a handover request to the second network device 103 corresponding to the first candidate cell, and then send the handover command to the user equipment 101.

In the step S502, the user equipment 101 performs cell handover according to the handover command.

In some implementations, after receiving the handover command, the user equipment 101 may perform the cell handover, that is, disconnect from the first network device 102 and access the second network device 103.

In the step S503, the user equipment 101 sends indication information to the network device, and the indication information is configured to indicate that a handover process of handover of the user equipment from the serving cell to the first candidate cell has been completed. The network device includes the first network device 102 corresponding to the serving cell, or the second network device 103 corresponding to the first candidate cell.

In some implementations, when the network device is the first network device 102, after completing the cell handover, the user equipment 101 sends the indication information to the first network device 102. The first network device 102 sends the indication information to the second network device 103 based on the Xn interface.

In some implementations, when the network device is the second network device 103, after completing the cell handover, the user equipment 101 may send the indication information to the second network device 103.

In embodiments of the present disclosure, after receiving the handover instruction and completing the cell handover, the user equipment 101 sends the indication information to the first network device 102 or the second network device 103 to report in a timely manner to the second network device 103 that the user equipment 101 has completed the cell handover.

Embodiments of the present disclosure provide a method for sending indication information, which is performed by the user equipment 101.

The method includes steps S501, S502, S503-1 and S503-21. Specifically:
in the step S501, the user equipment 101 receives a handover command sent by the first network device 102.

In the step S502, the user equipment 101 performs cell handover according to the handover command.

In the step S503-1, after receiving the handover command, the user equipment 101 performs Channel State Information (CSI) measurement of the first candidate cell according to measurement configuration information.

In some implementations, the measurement configuration information may be sent by the first network device 102 to the user equipment 101. For example, before performing the candidate cell measurement, the first network device 102 sends the measurement configuration information to the user equipment 101.

In some implementations, the measurement configuration information includes a resource configuration related to the layer 1 measurement. The user equipment 101 performs the layer 1 measurement of the plurality of candidate cells based on the resource configuration related to the layer 1 measurement, and reports the layer 1 measurement result to the first network device 102.

In the implementation, the first network device 102 makes a decision based on the layer 1 measurement result to determine the first candidate cell (i.e., the target cell) among the plurality of candidate cells. After determining the first candidate cell, and the first network device 102 may send the handover request to the second network device 103 corresponding to the first candidate cell, and then send the handover command to the user equipment 101.

In some implementations, the handover command may include information of the first candidate cell.

In some implementations, the measurement configuration information also includes a relevant configuration of the first candidate cell (i.e., the target cell), such as a CSI measurement configuration (csi-MeasConfig) of the first candidate cell. After receiving the handover command, the user equipment 101 performs the CSI measurement of the first candidate cell according to the csi-MeasConfig of the first candidate cell.

In some implementations, csi-MeasConfig includes, for example, a resource configuration related to the Channel State Information (CSI) measurement.

In an example, the resource configuration related to the CSI measurement may be a CSI-Report configuration and a CSI-Resource configuration. The CSI-Resource configuration is configured to indicate a parameter that the user equipment 101 needs to measure in the CSI measurement, and the CSI-Report configuration is configured to indicate a measurement quantity or a parameter value that the user equipment 101 needs to report after the CSI measurement, that is, the measurement quantity obtained by measuring a parameter of the CSI-Resource configuration.

In an example, the CSI-Resource includes a CSI-RS resource, and the CSI-Report includes the CQI.

In this example, after the user equipment 101 performs the CSI measurement based on the CSI-RS resource, it obtains a corresponding CSI measurement result, such as a Channel Quality Indication (CQI) value.

In the step S503-21, the user equipment 101 sends indication information to the first network device 102, and the indication information includes non-zero Channel Quality Indication (CQI) determined based on the CSI measurement.

In some implementations, when the CQI is 0, the CQI is invalid. When the CQI value is not obtained, the measurement result corresponding to the CQI is also invalid.

In some implementations, when the CQI is a non-zero value, it indicates that the CQI is valid, that is, a valid parameter of the channel state information of the first candidate cell is obtained. In the implementation, when the indication information includes the valid CQI, it is used to indicate that the user equipment 101 has completed the cell handover.

In some implementations, after receiving the indication information carrying the valid CQI, the first network device 102 learns that the user equipment 101 completes the cell handover, and can send the indication information to the second network device 103. This method is suitable for a scenario where the second network device 103 may not monitor the uplink information of the user equipment 101 in a timely manner. The user equipment 101 first sends the indication information to the first network device 102 of the serving cell, and the indication information is timely transmitted based on a communication mode between the network devices, so as to ensure that the second network device 103 can timely learn the handover status of the user equipment 101.

Alternatively, the method includes steps S501, S502, S503-1 and S503-22. Specifically:
in the step S501, the user equipment 101 receives a handover command sent by the first network device 102.

In the step S502, the user equipment 101 performs cell handover according to the handover command.

In the step S503-1, after receiving the handover command, the user equipment 101 performs Channel State Information (CSI) measurement of the first candidate cell according to measurement configuration information.

In the step S503-22, the user equipment 101 sends indication information to the second network device 103, and the indication information includes non-zero Channel Quality Indication (CQI) determined based on the CSI measurement.

In some implementations, after obtaining the CSI measurement result, the user equipment 101 may directly send the indication information carrying the CQI to the second network device 103. In this method, in combination with the change in the channel quality of the cell before and after the handover in the handover scenario, compared with the first network device 102, the communication quality between the user equipment 101 and the second network device 103 may be better, so the method in which the user equipment 101 directly reports the indication information to the second network device 103 can reduce an information delay, reduce a transmission delay, and further ensure that the second network device 103 learns in time that the user equipment 101 completes the cell handover and can quickly perform scheduling.

It can be understood that embodiments in the method of the present disclosure can be executed independently or in combination, and for relevant implementations of the method, reference may be made to the description of the aforementioned embodiments, which are not repeated here.

In embodiments of the present disclosure, after receiving the handover command from the first network device 102, the user equipment 101 may perform the cell handover and the CSI measurement of the first candidate cell to obtain the CQI corresponding to the first candidate cell. The user equipment 101 may report the indication information carrying the valid CQI to the first network device 102, so as to inform the second network device 103 through the first network device 102 that the user equipment 101 has completed the cell handover. The user equipment 101 may also directly report the indication information carrying the valid CQI to the second network device 103, so as to directly inform the second network device 103 that the user equipment 101 has completed the cell handover.

Embodiments of the present disclosure provide a method for sending indication information, which is performed by the user equipment 101.

The method includes steps S501, S502 and S503-31. Specifically:
in the step S501, the user equipment 101 receives a handover command sent by the first network device 102.

In the step S502, the user equipment 101 performs cell handover according to the handover command.

In the step S503-31, after the handover process is completed, the user equipment 101 sends a Media Access Control Control Element (MAC-CE) signaling to the first network device 102, and the MAC-CE signaling is configured to determine the indication information.

In some implementations, the MAC-CE signaling may directly include the indication information, or indirectly indicate the corresponding indication information.

In some implementations, 1 bit of information in the MAC-CE signaling may be used to indicate whether the user equipment 101 has completed the cell handover. For example, when a value of the bit is 1, it indicates that the user equipment 101 has completed the cell handover. Alternatively, when the value of the bit is 0, it indicates that the user equipment 101 has completed the cell handover.

In embodiments of the present disclosure, the user equipment 101 sends the indication information to the first network device 102 through the MAC-CE signaling, so as to inform the second network device 103 through the first network device 102 in a timely manner that the user equipment 101 has completed the cell handover.

Alternatively, the method includes steps S501, S502 and S503-32. Specifically:
in the step S501, the user equipment 101 receives a handover command sent by the first network device 102.

In the step S502, the user equipment 101 performs cell handover according to the handover command.

In the step S503-32, after the handover process is completed, the user equipment 101 sends a Media Access Control Control Element (MAC-CE) signaling to the second network device 103, and the MAC-CE signaling is configured to determine the indication information.

In some implementations, the MAC-CE signaling may directly or indirectly indicate the indication information.

In some implementations, 1 bit of information in the MAC-CE signaling may be used to indicate whether the user equipment 101 has completed the cell handover. For example, when a value of the bit is 1, it indicates that the user equipment 101 has completed the cell handover. Alternatively, when the value of the bit is 0, it indicates that the user equipment 101 has completed the cell handover.

In embodiments of the present disclosure, the user equipment 101 sends the indication information to the second network device 103 through the MAC-CE signaling, so as to directly report to the second network device 103 that the cell handover has been completed.

It can be understood that embodiments in the method of the present disclosure can be executed independently or in combination, and for relevant implementations of the method, reference may be made to the description of the aforementioned embodiments, which are not repeated here.

Embodiments of the present disclosure provide a method for sending indication information, which is performed by user equipment 101.

The method includes steps S501, S502 and S503-41. Specifically:
in the step S501, the user equipment 101 receives a handover command sent by the first network device 102.

In the step S502, the user equipment 101 performs cell handover according to the handover command.

In the step S503-41, after the handover process is completed, the user equipment 101 sends Uplink Control Information (UCI) to the first network device 102, and the UCI is configured to determine the indication information.

In some implementations, the UCI may directly include the indication information, or indirectly indicate the indication information.

In some implementations, 1 bit of information in the UCI may be used to indicate whether the user equipment 101 has completed the cell handover. For example, when a value of the bit is 1, it indicates that the user equipment 101 has completed the cell handover. Alternatively, when the value of the bit is 0, it indicates that the user equipment 101 has completed the cell handover.

In embodiments of the present disclosure, the user equipment 101 sends the indication information to the first network device 102 through the UCI, so as to inform the second network device 103 through the first network device 102 in a timely manner that the user equipment 101 has completed the cell handover.

The method includes steps S501, S502 and S503-42. Specifically:
in the step S501, the user equipment 101 receives a handover command sent by the first network device 102.

In the step S502, the user equipment 101 performs cell handover according to the handover command.

In the step S503-42, after the handover process is completed, the user equipment 101 sends Uplink Control Information (UCI) to the second network device 103, and the UCI is configured to determine the indication information.

In some implementations, the UCI may directly or indirectly indicate the indication information.

In some implementations, 1 bit of information in the UCI may be used to indicate whether the user equipment 101 has completed the cell handover. For example, when a value of the bit is 1, it indicates that the user equipment 101 has completed the cell handover. Alternatively, when the value of the bit is 0, it indicates that the user equipment 101 has completed the cell handover.

In embodiments of the present disclosure, the user equipment 101 sends the indication information to the second network device 103 through the UCI, so as to directly report to the second network device 103 that the cell handover has been completed.

It can be understood that embodiments in the method of the present disclosure can be executed independently or in combination, and for relevant implementations of the method, reference may be made to the description of the aforementioned embodiments, which are not repeated here.

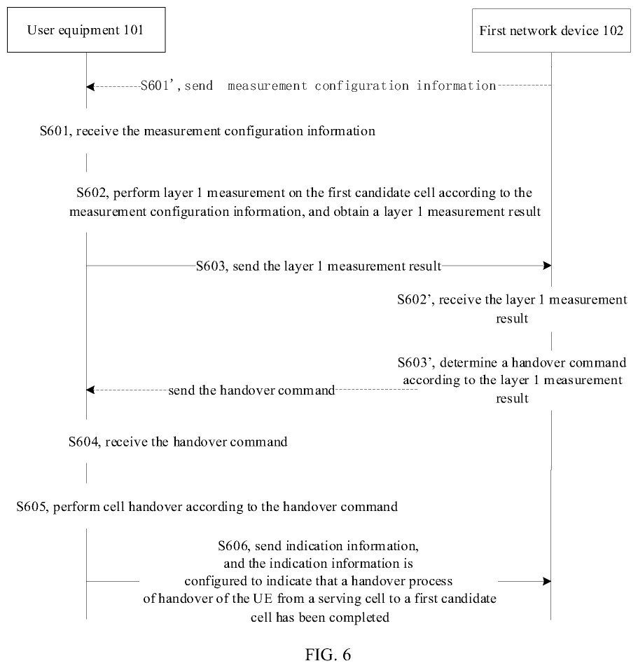

Embodiments of the present disclosure provide a method for sending indication information, which is performed by the user equipment 101. Reference is made to FIG. 6, which shows a method for transmitting indication information according to an embodiment. As shown in FIG. 6, the method includes steps S601 to S606. Specifically:
in the step S601, the user equipment 101 receives measurement configuration information sent by the first network device 102.

In some implementations, the measurement configuration information may be sent by the first network device 102 to the user equipment 101 before the candidate cell measurement is performed.

In some implementations, the measurement configuration information includes a resource configuration related to the layer 1 measurement, such as a resource configuration of a reference signal to be measured.

In some implementations, the measurement configuration information may include a plurality of sets of layer 1 measurement configurations, and each set of layer 1 measurement configurations corresponds to a candidate cell.

In the step S602, the user equipment 101 performs the layer 1 measurement on the first candidate cell according to the measurement configuration information to obtain the layer 1 measurement result.

In some implementations, the user equipment 101 performs, according to the measurement configuration information, the layer 1 measurement on the plurality of candidate cells, respectively, and obtains a layer 1 measurement result corresponding to each candidate cell.

For example, the user equipment 101 performs the layer 1 measurement on the first candidate cell according to the layer 1 measurement configuration corresponding to the first candidate cell, and obtains the layer 1 measurement result of the first candidate cell.

In some implementations, the layer 1 measurement result of the first candidate cell may include one of: a Layer 1 Reference Signal Received Power (L1-RSRP), a Layer 1 Reference Signal Received Quality (L1-RSRQ), or a Layer 1 Signal to Interference plus Noise Ratio (L1-SINR).

A process based on the layer 1 measurement has a lower measurement delay than a process based on the layer 3 measurement. On the basis of reducing the measurement delay, the cell handover process based on the layer 1 measurement is conducive to improving the throughput and mobility performance of the serving cell, especially in a handover scenario with the small cell coverage in the FR2 scenario.

In the step S603, the user equipment 101 sends a layer 1 measurement result to the first network device 102.

In some implementations, after obtaining the layer 1 measurement result of each candidate cell, the user equipment 101 may send the layer 1 measurement result of each candidate cell to the first network device 102. For example, the user equipment 101 sends the measurement result corresponding to the first candidate cell to the first network device 102.

In some implementations, the first network device 102 may make a decision based on the layer 1 measurement results of the plurality of candidate cells, and send a handover request to a network device corresponding to each candidate cell. The first network device 102 determines, according to the received handover request, the first candidate cell to be handed over and the handover command, and sends the handover command to the user equipment 101. The handover command may include information of the first candidate cell.

In the step S604, the user equipment 101 receives a handover command sent by the first network device 102.

In the step S605, the user equipment 101 performs cell handover according to the handover command.

In the step S606, the user equipment 101 sends indication information to the network device, and the indication information is configured to indicate that a handover process of handover of the user equipment 101 from the serving cell to the first candidate cell has been completed. The network device includes the first network device 102 corresponding to the serving cell, or the second network device 103 corresponding to the first candidate cell.

It can be understood that embodiments in the method of the present disclosure can be executed independently or in combination, and for relevant implementations of the method, reference may be made to the description of the aforementioned embodiments, which are not repeated here.

In embodiments of the present disclosure, by describing the measurement and the cell handover process of the user equipment 101, the timing for the user equipment 101 to send the indication information can be indicated.

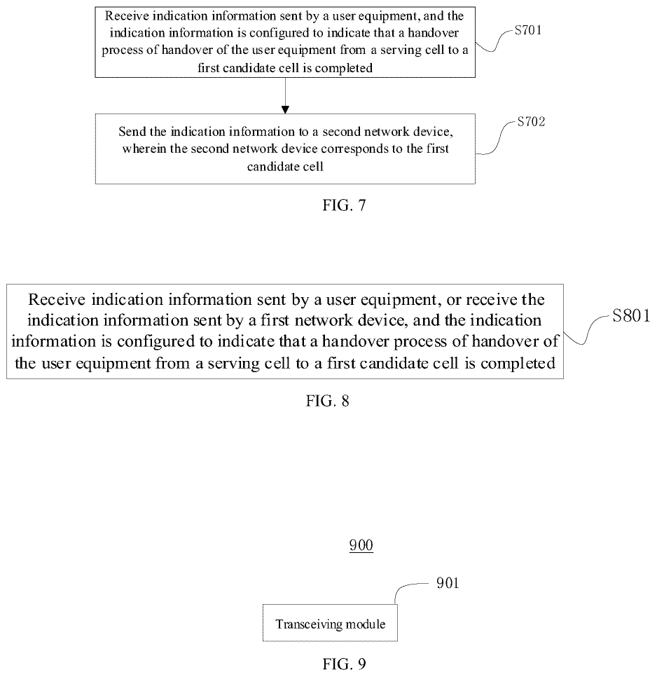

Embodiments of the present disclosure provide a method for transmitting indication information, which is performed by the first network device 102. Reference is made to FIG. 7, which shows a method for transmitting indication information according to an embodiment. As shown in FIG. 7, the method includes steps S701 to S702. Specifically:

in the step S701, the first network device 102 receives indication information sent by the user equipment 101, and the indication information is configured to indicate that a handover process of handover of the user equipment 101 from a serving cell to a first candidate cell has been completed.

The first network device 102 is a network device corresponding to the serving cell.

In some implementations, the first network device 102 may receive the indication information sent by the user equipment 101 through the MAC-CE signaling or the UCI.

In the step S702, the first network device 102 sends the indication information to the second network device 103, and the second network device 103 corresponds to the first candidate cell.

In some implementations, the first network device 102 may not process the indication information, and directly forward it to the second network device 103.

In some implementations, the first network device 102 sends the indication information to the second network device 103 through the Xn interface.

It can be understood that embodiments in the method of the present disclosure can be executed independently or in combination, and for relevant implementations of the method, reference may be made to the description of the aforementioned embodiments, which are not repeated here.

In embodiments of the present disclosure, after receiving the indication information reported by the user equipment 101, the first network device 102 may forward the indication information to the second network device 103 to inform the second network device 103 that the user equipment 101 completes the cell handover.

Embodiments of the present disclosure provide a method for transmitting indication information, which is performed by the first network device 102. The method includes steps S700 to S702. Specifically:
in the step S700, the first network device 102 sends a handover command to the user equipment 101.

In some implementations, the first network device 102 sends the handover command through the MAC-CE signaling to indicate to the user equipment 101 to perform cell handover.

In some implementations, after receiving the layer 1 measurement results of the user equipment 101 based on the plurality of candidate cells, the first network device 102 sends the handover command.

In some implementations, the handover command may include information of the first candidate cell.

In the step S701, the first network device 102 receives the indication information sent by the user equipment 101, and the indication information is configured to indicate that a handover process of handover of the user equipment from a serving cell to a first candidate cell has been completed.

In some implementations, the step S701 may include the following step S701-1. Specifically:
in the step S701-1, the first network device 102 receives the indication information sent by the user equipment 101, and the indication information includes non-zero CQI determined by the user equipment 101 based on the CSI measurement of the first candidate cell.

In the implementation, after receiving the indication information carrying the valid CQI, the first network device 102 learns that the user equipment 101 completes the cell handover.

In some implementations, the step S701 may include the following step S701-2. Specifically:
in the step S701-2, the first network device 102 receives a MAC-CE signaling sent by the user equipment 101, and the MAC-CE signaling is configured to determine the indication information.

In the implementation, the first network device 102 may determine, in combination with a value of a corresponding bit in the MAC-CE signaling, whether the user equipment 101 completes the cell handover.

In some implementations, the step S701 may include the following step S701-3. Specifically:
in the step S701-3, the first network device 102 receives UCI sent by the user equipment 101, and the UCI is configured to determine the indication information.

In the implementation, the first network device 102 may determine, in combination with a value of a corresponding bit in the UCI, whether the user equipment 101 completes the cell handover.

In the step S702, the first network device 102 sends the indication information to the second network device 103, and the second network device 103 corresponds to the first candidate cell.

It can be understood that embodiments in the method of the present disclosure can be executed independently or in combination, and for relevant implementations of the method, reference may be made to the description of the aforementioned embodiments, which are not repeated here.

In embodiments of the present disclosure, after sending the handover command to the user equipment 101, the first network device 102 can receive the indication information sent, in a variety of ways, by the user equipment 101, and then send the indication information to the second network device 103 to inform the second network device 103 that the user equipment 101 completes the cell handover.

Embodiments of the present disclosure provide a method for transmitting indication information, which is performed by the first network device 102. Reference is still made to FIG. 6, which shows a method for transmitting indication information according to an embodiment, and the method includes steps S601′ to S603′. Specifically:
in the step S601′, the first network device 102 sends measurement configuration information to the user equipment 101.

In some implementations, the measurement configuration information includes a resource configuration related to the layer 1 measurement, and may also include a CSI measurement configuration of the first candidate cell.

In the step S602′, the first network device 102 receives the layer 1 measurement result sent by the user equipment 101.

In some implementations, the first network device 102 may receive layer 1 measurement results corresponding to a plurality of candidate cells sent by the user equipment 101.

In some implementations, the first network device 102 makes a decision based on the layer 1 measurement result to determine the first candidate cell (i.e., the target cell) among the plurality of candidate cells. After determining the first candidate cell, and the first network device 102 may send the handover request to the second network device 103 corresponding to the first candidate cell, and then send the handover command to the user equipment 101.

In the step S603′, the first network device 102 determines a handover command according to the layer 1 measurement result.

In some implementations, the handover command may include information of the first candidate cell.

In embodiments of the present disclosure, before receiving the indication information, the first network device 102 may send corresponding measurement configuration information, so that the user equipment 101 can perform the cell measurement and the handover process.

Embodiments of the present disclosure provide a method for receiving indication information, which is performed by the second network device 103. Reference is made to FIG. 8, which shows a method for receiving indication information according to an embodiment. As shown in FIG. 8, the method includes a step S801. Specifically:
in the step S801, the second network device 103 receives indication information sent by the user equipment 101, or receives the indication information sent by the first network device 102, and the indication information is configured to indicate that a handover process of handover of the user equipment 101 from the serving cell to the first candidate cell has been completed; and the first network device 102 corresponds to the serving cell, and the second network device 103 corresponds to the first candidate cell.

In some implementations, the signaling interaction or information interaction between the first network device 102 and the second network device 103 is performed based on the Xn interface. The first network device 102 can send, through the Xn interface, the indication information received from the user equipment 101 to the second network device 103.

In some implementations, the second network device 103 may receive the indication information directly sent by the user equipment 101.

In some implementations, the indication information includes non-zero CQI determined by the user equipment 101 based on the CSI measurement of the first candidate cell.

In the implementation, when the CQI is non-zero, that is, the CQI is valid, it indicates that the user equipment 101 has completed the cell handover.

In some implementations, the user equipment 101 may send the indication information through the MAC-CE signaling or the UCI.

In some implementations, the step S801 may include the following step S801-1 or step S801-2.

In the step S801-1, the second network device 103 receives the MAC-CE signaling sent by the user equipment 101, and the MAC-CE signaling is configured to determine the indication information.

In the step S801-2, the second network device 103 receives the UCI sent by the user equipment 101, and the UCI is configured to determine the indication information.

In embodiments of the present disclosure, the second network device 103 may receive the indication information sent by the user equipment 101 or the first network device 102 to learn that the user equipment 101 completes the cell handover, so as to perform reasonable operations at an appropriate time.

Embodiments of the present disclosure provide a method for receiving indication information, which is performed by the second network device 103. The method includes steps S801 to S802. Specifically:
in the step S801, the second network device 103 receives indication information sent by the user equipment 101, or receives the indication information sent by the first network device 102, and the indication information is configured to indicate that a handover process of handover of the user equipment 101 from the serving cell to the first candidate cell has been completed.

In the step S802, after receiving the indication information, the second network device 103 schedules the user equipment 101.

In some implementations, after receiving the indication information, the second network device 103 may schedule the user equipment 101 in a timely manner, such as scheduling a PDCCH or a PDSCH.

In embodiments of the present disclosure, after receiving the indication information, the second network device 103 can promptly learn that the user equipment 101 has completed the cell handover, so as to schedule the user equipment 101 in a timely manner, thereby improving the communication efficiency and the system performance.

To facilitate understanding of embodiments of the present disclosure, some specific examples are listed below.

An embodiment of the present disclosure involves a method for a network device (i.e., the second network device 103) of a target cell to obtain indication information that a UE 101 has completed the cell handover. A network device (i.e., the first network device 102) of the serving cell sends a cell handover command to the UE 101 through the MAC-CE signaling, and the UE 101 performs the cell handover after receiving the handover command. When the UE 101 completes the cell handover, the indication information that the cell handover has been completed may be sent to the target cell in the following manner.

### First Manner:

the UE sends to the serving cell (a source cell in the embodiment) indication information that the cell handover is completed.

The first manner may include the following steps 1 and 2. Specifically:
in step 1, the UE sends to the serving cell the indication information that the cell handover is completed; and
in step 2, the serving cell sends the indication information to the target cell via the Xn interface.

The indication information may be valid CQI measured on the target cell and reported by the UE to the serving cell. Alternatively, the UE reports, by means of the MAC-CE or the UCI, to the serving cell the indication information that the target cell handover is completed.

During the implementation of the first manner, the following two application scenarios can be included:
Scenario 1: the serving cell sends the cell handover command to the UE by means of the MAC-CE. After receiving the handover command, the UE performs the cell handover. In addition, the UE performs the CSI measurement according to the configuration of csi-MeasConfig in the target cell configuration. When the UE reports the valid CQI (i.e., the non-zero CQI) of the target cell to the serving cell, that is, when the serving cell receives the valid CQI feedback from the UE, the serving cell considers that the UE has completed the target cell handover. The serving cell sends, via the Xn interface, to the target cell the indication information that the UE has completed the cell handover.
Scenario 2: the serving cell sends the cell handover command to the UE by means of the MAC-CE. After the UE executes and completes the target cell handover, it reports, by means of the MAC-CE message or the UCI indication, to the serving cell the indication information that the target cell handover is completed, and then the serving cell sends, via the Xn interface, to the target cell the indication information that the UE completes the cell handover.

### Second Manner:

The UE 101 sends to the target cell indication information that the cell handover is completed.

During the implementation of the second manner, the following two application scenarios can be included:
Scenario 3: the serving cell sends the cell handover command to the UE by means of the MAC-CE. After the UE executes and completes the target cell handover, it reports, by means of the MAC-CE message or the UCI indication, to the target cell the indication information that the cell handover is completed. After receiving the indication information that the cell handover is completed from the UE, the target cell starts scheduling the UE (such as scheduling the PDCCH or the PDSCH).

Scenario 4: the serving cell sends the cell handover command to the UE by means of the MAC-CE. After receiving the handover command, the UE performs the cell handover. In addition, the UE performs the CSI measurement according to the configuration of csi-MeasConfig in the target cell configuration. When the UE reports the valid CQI (i.e., the non-zero CQI) to the target cell, the target cell considers that the UE has completed the target cell handover.

Based on the same concept as the above method embodiments, embodiments of the present disclosure further provide an apparatus for sending indication information, which may have the functions of the user equipment 101 in the above method embodiments, and can be configured to perform steps performed by the user equipment 101 according to the above method embodiments. These functions may be implemented by hardware, or may be implemented by software or by hardware executing corresponding software. The hardware or software includes one or more modules corresponding to the above functions.

In an implementation, an apparatus 900 shown in FIG. 9 may be used as the user equipment 101 involved in the above method embodiments, and perform the steps performed by the user equipment 101 in the above method embodiments. As shown in FIG. 9, the apparatus 900 may include a transceiving module 901, and the transceiving module 901 may be configured to support the communication device to communicate.

When performing the steps implemented by the user equipment 101, the transceiving module 901 is configured to send indication information to a network device, wherein the indication information is configured to indicate that a handover process of handover of the user equipment from a serving cell to a first candidate cell has been completed; and the network device includes a first network device corresponding to the serving cell, or a second network device corresponding to the first candidate cell.

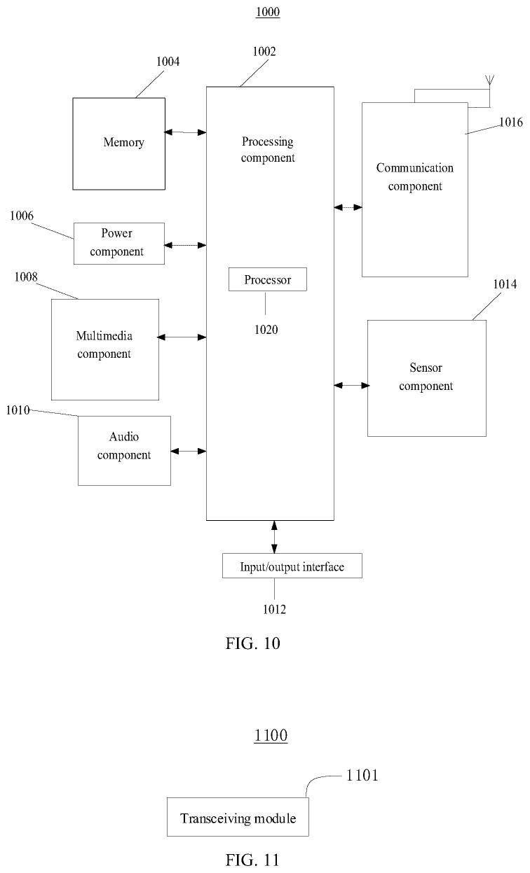

When the apparatus is the user equipment 101, its structure may also be as shown in FIG. 10. The apparatus 1000 may be a mobile phone, a computer, a digital broadcast terminal, a messaging device, a gaming console, a tablet device, a medical device, an exercise device, a personal digital assistant, etc.

Referring to FIG. 10, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the apparatus 1000, such as the operations associated with display, telephone calls, data communications, camera operations, and recording operations. The processing component 1002 may include one or more processors 1020 to execute instructions to perform all or part of the steps in the above described methods. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the apparatus 1000. Examples of such data include instructions for any applications or methods operated on the apparatus 1000, contact data, phonebook data, messages, pictures, video, etc. The memory 1004 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the apparatus 1000. The power component 1006 may include a power management system, one or more power sources, and any other components associated with the generation, management, and distribution of power in the apparatus 1000.

The multimedia component 1008 includes a screen providing an output interface between the apparatus 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 1008 includes a front camera and/or a rear camera. The front camera and the rear camera may receive an external multimedia datum while the apparatus 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (MIC) configured to receive an external audio signal when the apparatus 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide state assessments of various aspects of the apparatus 1000. For instance, the sensor component 1014 may detect an open/closed state of the apparatus 1000, relative positioning of components, e.g., the display and the keypad, of the apparatus 1000, a change in position of the apparatus 1000 or a component of the apparatus 1000, a presence or absence of user contact with the apparatus 1000, an orientation or an acceleration/deceleration of the apparatus 1000, and a change in temperature of the apparatus 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the apparatus 1000 and other devices. The apparatus 1000 may access a wireless network based on a communication standard, such as WiFi, 2G, or 3G, or a combination thereof. In an embodiment, the communication component 1016 receives a broadcast signal or broadcast associated information from an external broadcast management system via a broadcast channel. In an embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the apparatus 1000 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 1004 including instructions, the above instructions may be executed by the processor 1020 in the apparatus 1000 for performing the above-described methods. For example, the non-transitory computer-readable storage medium may be a ROM, a Random Access Memory (RAM), a CD-ROM, a magnetic tape, a floppy disc, an optical data storage device, and the like.

Based on the same concept as the above method embodiments, embodiments of the present disclosure further provide an apparatus for transmitting indication information, which may have the functions of the first network device 102 in the above method embodiments, and can be configured to perform steps performed by the first network device 102 according to the above method embodiments. These functions may be implemented by hardware, or may be implemented by software or by hardware executing corresponding software. The hardware or software includes one or more modules corresponding to the above functions.

In an implementation, the communication device 1100 shown in FIG. 11 may serve as the first network device 102 involved in the above method embodiments, and perform the steps performed by the first network device 102 in the above method embodiments. As shown in FIG. 11, the communication device 1100 may include a transceiving module 1101, and the transceiving module 1101 may be configured to support the communication device to communicate. The transceiving module 1101 may have a wireless communication function, for example, being able to wirelessly communicate with other communication devices through a wireless air interface.

When performing the steps implemented by the first network device 102, the transceiving module 1101 is configured to receive indication information sent by a user equipment, and the indication information is configured to indicate that a handover process of handover of the user equipment from the serving cell to a first candidate cell has been completed.

The transceiving module 1101 is configured to send the indication information to a second network device, and the second network device corresponds to the first candidate cell.

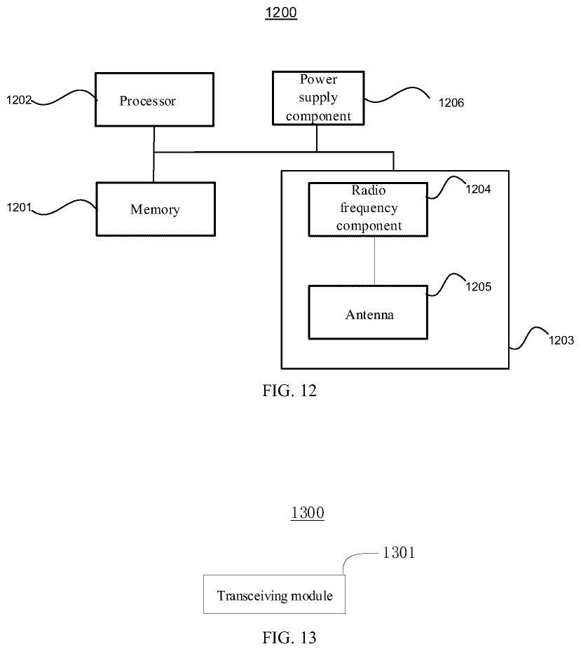

When the communication device is the first network device 102, its structure may also be as shown in FIG. 12. The structure of the communication device will be described by taking the base station as an example. As shown in FIG. 12, the apparatus 1200 includes a memory 1201, a processor 1202, a transceiver component 1203, and a power supply component 1206. The memory 1201 is coupled with the processor 1202, and may be configured to store programs and data necessary for the communication device 1200 to realize various functions. The processor 1202 is configured to support the communication device 1200 to perform the corresponding functions in the above-mentioned methods, and the functions can be implemented by invoking programs stored in the memory 1201. The transceiver component 1203 may be a wireless transceiver, and may be configured to support the communication device 1200 to receive signaling and/or data, and to transmit signaling and/or data through a wireless air interface. The transceiver component 1203 may also be referred to as a transceiver unit or a communication unit, and the transceiver component 1203 may include a radio frequency component 1204 and one or more antennas 1205. The radio frequency component 1204 may be a remote radio unit (RRU), and may be specifically used for the transmission of radio frequency signals and conversion between radio frequency signals and baseband signals. The one or more antennas 405 may be specifically used for radiation and reception of radio frequency signals.

When the communication device 1200 needs to send data, the processor 1202 may carry out baseband processing on the data to be sent, and output the baseband signal to the radio frequency unit. The radio frequency unit carries out the radio frequency processing on the baseband signal and sends the radio frequency signal through the antenna in the form of electromagnetic waves. When data is sent to the communication device 1200, the radio frequency unit receives the radio frequency signal through the antenna, converts the radio frequency signal into the baseband signal, and outputs the baseband signal to the processor 1202. Then the processor 1202 converts the baseband signal into data and process the data.

Based on the same concept as the above method embodiments, embodiments of the present disclosure further provide an apparatus for receiving indication information, which may have the functions of the second network device 103 in the above method embodiments, and can be configured to perform steps performed by the second network device 103 according to the above method embodiments. These functions may be implemented by hardware, or may be implemented by software or by hardware executing corresponding software. The hardware or software includes one or more modules corresponding to the above functions.

In an implementation, the communication device 1300 shown in FIG. 13 may be used as the second network device 103 involved in the above method embodiments, and perform the steps performed by the second network device 103 in the above method embodiments. As shown in FIG. 13, the communication device 1300 may include a transceiving module 1201, and the transceiving module 1301 may be configured to support the communication device to communicate. The transceiving module 1301 may have a wireless communication function, for example, being able to communicate wirelessly with other communication devices through a wireless air interface.

When performing the steps implemented by the second network device 103, the transceiving module 1301 is configured to receive indication information sent by a user equipment, or receive the indication information sent by a first network device, and the indication information is configured to indicate that a handover process of handover of the user equipment from a serving cell to a first candidate cell has been completed. The first network device corresponds to the serving cell.

When the communication device is the second network device 103, its structure can also refer to that shown in FIG. 12.

The present disclosure provides a method and apparatus for transmitting indication information, and a readable storage medium.

In a first aspect, the present disclosure provides a method for sending indication information, which is performed by a user equipment, and the method includes:
sending indication information to a network device, wherein the indication information is configured to indicate that a handover process of handover of the user equipment from a serving cell to a first candidate cell is completed; and
wherein the network device includes a first network device corresponding to the serving cell, or a second network device corresponding to the first candidate cell.

In the method of the present disclosure, the user equipment may send the indication information to the first network device or the second network device, so as to inform the second network device through the first network device that the cell handover is completed, or report the completion of the cell handover to the second network device through the direct transmission. Thus, the second network device can timely learn that the user equipment has completed the cell handover, so as to perform reasonable operations at an appropriate time.

In some implementations, the method further includes:
receiving a handover command sent by the first network device; and
performing cell handover according to the handover command.

In some implementations, sending the indication information to the network device includes:
when receiving the handover command, performing Channel State Information (CSI) measurement of the first candidate cell according to measurement configuration information; and
sending the indication information to the second network device or the first network device, wherein the indication information includes non-zero Channel Quality Indication (CQI) determined based on the CSI measurement.

In some implementations, sending the indication information to the network device includes:
when completing the handover process, sending a Media Access Control Control Element (MAC-CE) signaling to the second network device or the first network device, wherein the MAC-CE signaling is configured to determine the indication information.

In some implementations, sending the indication information to the network device includes:
when completing the handover process, sending Uplink Control Information (UCI) to the second network device or the first network device, wherein the UCI is configured to determine the indication information.

In some implementations, the method further includes:
receiving measurement configuration information sent by the first network device;
performing layer 1 measurement on the first candidate cell according to the measurement configuration information to obtain a layer 1 measurement result; and sending the layer 1 measurement result to the first network device.

In a second aspect, the present disclosure provides a method for transmitting indication information, which is performed by a first network device corresponding to a serving cell, and the method includes:
receiving indication information sent by a user equipment, wherein the indication information is configured to indicate that a handover process of handover of the user equipment from the serving cell to a first candidate cell is completed; and
sending the indication information to a second network device, wherein the second network device corresponds to the first candidate cell.

In embodiments of the present disclosure, after receiving the indication information reported by the user equipment, the first network device may forward the indication information to the second network device to inform the second network device that the user equipment has completed the cell handover.

In some implementations, the method further includes:
sending a handover command to the user equipment.

In some implementations, receiving the indication information sent by the user equipment includes:
receiving the indication information sent by the user equipment, wherein the indication information includes non-zero CQI determined by the user equipment based on CSI measurement of the first candidate cell.

In some implementations, receiving the indication information sent by the user equipment includes:
receiving a MAC-CE signaling sent by the user equipment, wherein the MAC-CE signaling is configured to determine the indication information.

In some implementations, receiving the indication information sent by the user equipment includes:
receiving UCI sent by the user equipment, wherein the UCI is configured to determine the indication information.

In some implementations, the method further includes:
sending measurement configuration information to the user equipment;
receiving a layer 1 measurement result sent by the user equipment; and
determining a handover command according to the layer 1 measurement result.

In a third aspect, the present disclosure provides a method for receiving indication information, which is performed by a second network device corresponding to a first candidate cell, and the method includes:
receiving indication information sent by a user equipment, or receiving the indication information sent by a first network device, wherein the indication information is configured to indicate that a handover process of handover of the user equipment from a serving cell to the first candidate cell is completed; and
wherein the first network device corresponds to the serving cell.

In the method of the present disclosure, the second network device may receive the indication information sent by the user equipment or the first network device to learn that the user equipment completes the cell handover, so as to perform reasonable operations at an appropriate time.

In some implementations, the indication information includes:
non-zero CQI determined by the user equipment based on CSI measurement of the first candidate cell.

In some implementations, receiving the indication information sent by the user equipment includes one of:
receiving a MAC-CE signaling sent by the user equipment, wherein the MAC-CE signaling is configured to determine the indication information; or
receiving UCI sent by the user equipment, wherein the UCI is configured to determine the indication information.

In some implementations, the method further includes:
when receiving the indication information, scheduling the user equipment.

In a fourth aspect, the present disclosure provides an apparatus for sending indication information, and the apparatus may be configured to perform steps performed by the user equipment in the first aspect or any possible design thereof. The user equipment may implement each function in the above-mentioned methods in the form of a hardware structure, a software module, or a combination of the hardware structure and the software module.

When the apparatus shown in the fourth aspect is implemented by the software module, the apparatus may include a transceiving module, and the transceiving module may be configured to support the communication device to communicate.

When performing the steps described in the first aspect above, the transceiving module is configured to send indication information to a network device, wherein the indication information is configured to indicate that a handover process of handover of the user equipment from a serving cell to a first candidate cell is completed; wherein the network device includes a first network device corresponding to the serving cell, or a second network device corresponding to the first candidate cell.

In a fifth aspect, the present disclosure provides an apparatus for transmitting indication information, and the apparatus may be configured to perform steps performed by the first network device in the second aspect or any possible design thereof. The first network device may implement each function in the above-mentioned methods in the form of a hardware structure, a software module, or a combination of the hardware structure and the software module.

When the apparatus shown in the fifth aspect is implemented by the software module, the apparatus may include a transceiving module, and the transceiving module may be configured to support the communication device to communicate.

When performing the steps described in the second aspect above, the transceiving module is configured to receive indication information sent by a user equipment, wherein the indication information is configured to indicate that a handover process of handover of the user equipment from the serving cell to a first candidate cell is completed; and the transceiving module is further configured to send the indication information to a second network device, wherein the second network device corresponds to the first candidate cell.

In a sixth aspect, the present disclosure provides an apparatus for receiving indication information, and the apparatus may be configured to perform steps performed by the second network device in the third aspect or any possible design thereof. The second network device may implement each function in the above-mentioned methods in the form of a hardware structure, a software module, or a combination of the hardware structure and the software module.

When the apparatus shown in the sixth aspect is implemented by the software module, the apparatus may include a transceiving module, and the transceiving module may be configured to support the communication device to communicate.

When performing the steps described in the third aspect above, the transceiving module is configured to receive indication information sent by a user equipment, or receive the indication information sent by a first network device, wherein the indication information is configured to indicate that a handover process of handover of the user equipment from a serving cell to a first candidate cell is completed; and
wherein the first network device corresponds to the serving cell.

In a seventh aspect, the present disclosure provides a user equipment, including a processor and a memory; the memory is configured to store a computer program; and the processor is configured to perform the computer program to implement the first aspect or any possible design thereof.

In an eighth aspect, the present disclosure provides a network device, including a processor and a memory; the memory is configured to store a computer program; and the processor is configured to perform the computer program to implement the second aspect or any possible design thereof or the third aspect or any possible design thereof.

In a ninth aspect, the present disclosure provides a computer-readable storage medium having instructions (or called computer programs, programs) stored thereon, wherein the instructions, when invoked and executed on a computer, cause the computer to perform the first aspect or any possible design thereof.

In a tenth aspect, the present disclosure provides a computer-readable storage medium having instructions (or called computer programs, programs) stored thereon, wherein the instructions, when invoked and executed on a computer, cause the computer to perform the second aspect or any possible design thereof or the third aspect or any possible design thereof.

Other implementations of the disclosed embodiments will readily occur to those skilled in the art upon consideration of the specification and practice of the present disclosure. The present disclosure is intended to cover any variations, uses, or adaptations of the disclosed embodiments that follow the general principles of the disclosed embodiments and include common general knowledge or conventional technical means in the art not disclosed in the present disclosure. The specification and examples are to be regarded as exemplary only, with the actual scope and spirit of embodiments of the present disclosure being indicated by the following claims.

It should be understood that some embodiments of the present disclosure are not limited to the precise structures described above and illustrated in the accompanying drawings, and that various modifications and changes may be made without departing from the scope thereof. The scope of embodiments of the present disclosure is limited only by the appended claims.

### INDUSTRIAL APPLICABILITY

In the method of the present disclosure, the user equipment may send the indication information to the first network device or the second network device, so as to inform the second network device through the first network device that the cell handover is completed, or report the completion of the cell handover to the second network device through the direct transmission. Thus, the second network device can timely learn that the user equipment has completed the cell handover, so as to perform reasonable operations at an appropriate time.

1. A method for sending indication information, performed by a user equipment, and comprising:
sending indication information to a network device, wherein the indication information is configured to indicate that a handover process of handover of the user equipment from a serving cell to a first candidate cell is completed; and
wherein the network device comprises a first network device corresponding to the serving cell, or a second network device corresponding to the first candidate cell.

2. The method according to claim 1, wherein the method further comprises:
receiving a handover command sent by the first network device; and
performing cell handover according to the handover command.

3. The method according to claim 2, wherein sending the indication information to the network device comprises:
response to receiving the handover command, performing Channel State Information (CSI) measurement of the first candidate cell according to measurement configuration information; and
sending the indication information to the second network device or the first network device, wherein the indication information comprises non-zero Channel Quality Indication (CQI) determined based on the CSI measurement.

4. The method according to claim 2, wherein sending the indication information to the network device comprises:
in response to completing the handover process, sending a Media Access Control Control Element (MAC-CE) signaling to the second network device or the first network device, wherein the MAC-CE signaling is configured to determine the indication information.

5. The method according to claim 2, wherein sending the indication information to the network device comprises:
in response to completing the handover process, sending Uplink Control Information (UCI) to the second network device or the first network device, wherein the UCI is configured to determine the indication information.

6. The method according to claim 1, wherein the method further comprises:
receiving measurement configuration information sent by the first network device;
performing layer 1 measurement on the first candidate cell according to the measurement configuration information and obtaining a layer 1 measurement result; and
sending the layer 1 measurement result to the first network device.

7. A method for transmitting indication information, performed by a first network device corresponding to a serving cell, and comprising:
receiving indication information sent by a user equipment, wherein the indication information is configured to indicate that a handover process of handover of the user equipment from the serving cell to a first candidate cell is completed; and
sending the indication information to a second network device, wherein the second network device corresponds to the first candidate cell.

8. The method according to claim 7, wherein the method further comprises:
sending a handover command to the user equipment.

9. The method according to claim 8, wherein receiving the indication information sent by the user equipment comprises:
receiving the indication information sent by the user equipment, wherein the indication information comprises non-zero CQI determined by the user equipment based on CSI measurement of the first candidate cell.

10. The method according to claim 8, wherein receiving the indication information sent by the user equipment comprises:
receiving a MAC-CE signaling sent by the user equipment, wherein the MAC-CE signaling is configured to determine the indication information.

11. The method according to claim 8, wherein receiving the indication information sent by the user equipment comprises:
receiving UCI sent by the user equipment, wherein the UCI is configured to determine the indication information.

12. The method according to claim 7, wherein the method further comprises:
sending measurement configuration information to the user equipment;
receiving a layer 1 measurement result sent by the user equipment; and
determining a handover command according to the layer 1 measurement result.

13. A method for receiving indication information, performed by a second network device corresponding to a first candidate cell, and comprising:
receiving indication information sent by a user equipment, or receiving the indication information sent by a first network device, wherein the indication information is configured to indicate that a handover process of handover of the user equipment from a serving cell to the first candidate cell is completed; and
wherein the first network device corresponds to the serving cell.

14. The method according to claim 13, wherein the indication information comprises:
non-zero CQI determined by the user equipment based on CSI measurement of the first candidate cell.

15. The method according to claim 13, wherein receiving the indication information sent by the user equipment comprises one of:
receiving a MAC-CE signaling sent by the user equipment, wherein the MAC-CE signaling is configured to determine the indication information; or
receiving UCI sent by the user equipment, wherein the UCI is configured to determine the indication information.

16. The method according to claim 13, wherein the method further comprises:
in response to receiving the indication information, scheduling the user equipment.

17. (canceled)

18. (canceled)

19. (canceled)

20. A user equipment, comprising a processor and a memory, wherein:
the memory is configured to store a computer program; and
the processor is configured to perform the computer program to implement the method according to claim 1.

21. A first network device, comprising a processor and a memory, wherein:
the memory is configured to store a computer program; and
the processor is configured to perform the computer program to implement the method according to claim 7.

22. A non-transitory computer-readable storage medium having instructions stored thereon, wherein the instructions, when invoked and executed on a computer, cause the computer to perform the method according to claim 1.

23. (canceled)

24. A second network device, comprising a processor and a memory, wherein:
the memory is configured to store a computer program; and
the processor is configured to perform the computer program to implement the method according to claim 13.
